(19) United States
(12) Patent Application Publication
(10) Pub. No.: US 2021/0120228 A1
(43) Pub. Date: Apr. 22, 2021

(54) DEVICE AND METHOD FOR DISPLAYING A 3D IMAGE

(71) Applicant: Huawei Technologies Co., Ltd., Shenzhen (CN)

(72) Inventors: Tao LIN, Dongguan (CN); Panji SETIAWAN, Munich (DE)

(21) Appl. No.: 17/136,958

(22) Filed: Dec. 29, 2020

Related U.S. Application Data
(63) Continuation of application No. PCT/EP2018/067708, filed on Jun. 29, 2018.

(51) Int. Cl. H04N 13/395; G02B 30/52

(52) U.S. Cl. CPC H04N 13/395; H04N 13/332; G02B 30/52

(57) ABSTRACT

The invention relates to the technical field of Multifocal Plane Display (MFD) devices for displaying 3D images. In particular, the invention proposes a device for displaying a 3D image, wherein the 3D image is generated based on a 2D image and a depth map. The device includes a light source, a diffuser and a controller. The light source is configured to emit light beams, each light beam corresponding to a pixel of a 2D image. The diffuser is configured to diffuse the light beams, wherein the diffuser includes a plurality of diffuser elements distributed across a 3D volume, and each diffuser element is individually controllable to be transmissive or diffusive. The controller is configured to control each diffuser element to be transmissive or diffusive based on a depth map.

### CROSS-REFERENCE TO RELATED APPLICATIONS

This application is a continuation of International Application No. PCT/EP2018/067708, filed on Jun. 29, 2018, the disclosure of which is hereby incorporated by reference in its entirety.

### TECHNICAL FIELD

The invention relates to the technical field of Multifocal Plane Display (MFD) devices, and thus presents a device and method for displaying a three-dimensional (3D) image. In particular, the device and method of the invention are configured to display the 3D image based on a two-dimensional (2D) image and a depth map. A plurality of light beams are generated based on the 2D image, and selective diffusing of the light beams creates the 3D image.

### BACKGROUND

MFD devices can be employed in, for instance, Near Eye Display (NED), Near-To-Eye (NTE) or Head Mounted Display (HMD) applications or devices, and aim to achieve multifocal display of 3D images. Different MFD devices can be categorized into spatially multiplexed or temporally/time multiplexed implementations. In the time multiplexed implementations, the viewing distance (depth) of a displayed (single) 2D image from the eye is rapidly switched in synchronization with the rendering of frames of multiple focal planes, in order to create a flicker-free perception of a 3D image.

A major challenge of such MFD devices are the system requirements. In fact, the visibility of such a MFD device to be commercially deployed in the market depends largely on the computational load, hardware design, etc.

Numerous attempts have been made to address this challenge of the system requirements. For instance, some attempts proposed displaying a 3D image by having switchable layers, wherein each layer is aimed at displaying an image at a certain focal plane. These switchable layers are, for example, referred to as stacked switchable diffusers or liquid crystal diaphragms.

However, all attempts do not satisfyingly achieve a high precision rendering of the 3D image without requiring a high frame rate.

### SUMMARY

In view of the above-mentioned challenge, the invention aims to improve devices and methods for displaying 3D images. The invention has the object to provide a device for displaying a 3D image with lower system requirements. In particular, the invention aims for a device and method to render a 3D image with high precision without requiring a high frame rate.

The object of the invention is achieved by the solution provided in the enclosed independent claims. Advantageous implementations of the invention are further defined in the dependent claims.

In particular the invention proposes introducing a diffuser including a set of switchable diffuser elements for diffusing light beams to generate the 3D image. The depth can be changed in the diffuser by individually switching on/off selected diffuser elements.

A first aspect of the invention provides a device for displaying a 3D image, the device comprising a light source configured to emit light beams, each light beam corresponding to a pixel of a 2D image, and a diffuser configured to diffuse the light beams, wherein the diffuser includes a plurality of diffuser elements distributed across a three-dimensional volume, and each diffuser element is individually controllable to be transmissive or diffusive, and a controller configured to control each diffuser element to be transmissive or diffusive based on a depth map.

By individually controlling the different diffuser elements, the system requirements are relaxed compared to other devices for displaying 3D images. In particular, the individually controlling enables rendering the 3D image with high precision without requiring a high frame rate, i.e. particularly a lower frame rate than used in other time-multiplexed MFD devices. Key for achieving this is that the 3D image can be represented as a 2D image and a depth map. Hence, the set of switchable diffuser elements can be used to generate the 3D image based on the depth map.

The diffuser of the device may be constructed based on liquid crystals (as diffuser elements), which can be electronically controlled by applying electricity to them. As in the LCD context, the liquid crystals may be used to individually switch the pixels on and off.

In an implementation form of the first aspect, the diffuser elements are arranged in a plurality of layers.

The diffuser thus comprises a plurality of diffuser layers at different depths with respect to a viewer or with respect to an exit pupil of the device. Thus, the 3D image can be created with high precision by diffusing the light beams with layers selected according to the depth map.

In a further implementation form of the first aspect, the diffuser elements are arranged in columns, each column comprising diffuser elements located in different layers.

The diffuser elements are thus arranged in a particularly simple geometrical structure, which allows to control the diffuser elements of one column independently of the diffuser elements of any other column. Diffuser elements in the same column but in different layers correspond to different 3D image depths.

In a further implementation form of the first aspect, the controller is configured to select, for each column, one layer based on the depth map and to control the one diffuser element of the column which is located in the selected layer to be diffusive and to control the one or more diffuser elements of the column which are located in the one or more non-selected layers to be transmissive.

Thus, based on the depth map, a certain depth can be selected per column, in order to generate in sum the 3D image with a high precision.

In a further implementation form of the first aspect, the diffuser elements in each layer adjoin each other.

In other words, there are no gaps between the diffuser segments in any of the layers. Each layer can thus provide a coherent image, in the sense that there will be no noticeable gaps between any image segments provided by neighboring diffuser elements of the layer.

In a further implementation form of the first aspect, the layers are spaced apart from each other.

Thus, a great depth range can be achieved using a small number of layers (e.g., less than five layers).

In a further implementation form of the first aspect, there is one column per pixel, or there is one column per group of pixels, each group comprising several pixels.

In a further limitation form of the first aspect, each layer is associated with a different depth in the 3D image.

In further implementation form of the first aspect, the depth map includes information about a depth of each pixel of the 3D image.

Thus, the device can efficiently render a high-precision 3D image.

In a further implementation form of the first aspect, the depth map has a lower resolution than the 2D image.

Thus, the processing requirements in the device are reasonably low, while still achieving precisely rendered 3D images.

In further implementation form of the first aspect, the controller is further configured to decompose the 3D image into the 2D image and the depth map, to control the light source based on the 2D image, and to control the diffuser based on the depth map.

Thus, the device may receive one or more 3D images to be displayed, e.g., in a video stream, and the controller takes each 3D image and controls its display.

In a further implementation form of the first aspect, the controller is further configured to extract the 3D image from a video signal or stream containing a sequence of 3D images, which is received by the device.

In a further implementation of the first aspect, the controller is further configured to estimate a number of depths in the 3D image, and to obtain the depth map based on this depth estimate.

Thus, a particularly efficient and high precision rendering of the 3D image is achieved.

In a further implementation of the first aspect, the controller is further configured to calculate a predicted depth map for a next 3D image based on the depth map, and to obtain a depth estimate of the next 3D image based on the predicted depth map.

Accordingly, the device can operate with higher efficiency and less computational load.

In a further implementation form of the first aspect, the device further comprises a magnifier arranged on an exit side of the diffuser.

A user of the device can thus be provided with an enlarged view of the 3D image that is generated in the diffuser. The magnifier may be a magnifying lens, for example.

In further implementation form of the first aspect, the magnifier has a focal plane and the diffuser comprises a plurality of diffuser layers, the diffuser layers including: a first diffuser layer located in the focal plane or located between the focal plane and the magnifier, and one or more further diffuser layers located between the first diffuser layer and the magnifier.

Image regions with infinite depth, i.e. image regions associated with far-away objects or scenery, can be displayed on the first diffuser layer. The first diffuser layer being located in the focal plane of the magnifier has the advantage that a user can view the first diffuser layer without accommodating her or his eye—the first diffuser layer will appear to be at an infinite distance from the user. The one or more further diffuser layers will appear closer to the user.

A second aspect of the invention provides a method for displaying a three-dimensional (3D) image, the method comprising emitting light beams, each light beam corresponding to a pixel of a two-dimensional (2D) image, diffusing the light beams by individually controlling each of a plurality of diffusing elements distributed across a three-dimensional volume to be transmissive or diffusive based on a depth map.

In an implementation form of the second aspect, the diffuser elements are arranged in a plurality of layers.

In a further implementation form of the second aspect, the diffuser elements are arranged in columns, each column comprising diffuser elements located in different layers.

In a further implementation form of the second aspect, the method comprises selecting, for each column, one layer based on the depth map and controlling the one diffuser element of the column which is located in the selected layer to be diffusive and controlling the one or more diffuser elements of the column which are located in the one or more non-selected layers to be transmissive.

In a further implementation form of the second aspect, the diffuser elements in each layer adjoin each other.

In a further implementation form of the second aspect, the layers are spaced apart from each other.

In a further implementation form of the second aspect, there is one column per pixel, or there is one column per group of pixels, each group comprising several pixels.

In a further limitation form of the second aspect, each layer is associated with a different depth in the 3D image.

In further implementation form of the second aspect, the depth map includes information about a depth of each pixel of the 3D image.

In a further implementation form of the second aspect, the depth map has a lower resolution than the 2D image.

In further implementation form of the second aspect, the method further comprises decomposing the 3D image into the 2D image and the depth map, controlling the light source based on the 2D image, and controlling the diffuser based on the depth map.

In a further implementation form of the second aspect, the method further comprises extracting the 3D image from a received video signal or stream containing a sequence of 3D images.

In a further implementation of the second aspect, the method further comprises estimating a number of depths in the 3D image, and obtaining the depth map based on this depth estimate.

In a further implementation of the second aspect, the method further comprises calculating a predicted depth map for a next 3D image based on the depth map, and obtaining a depth estimate of the next 3D image based on the predicted depth map.

The method of the second aspect and its implementation forms achieve the advantages and effects described above for the device of the first aspect and its respective implementation forms.

A third aspect of the invention provides a computer program product comprising a program code for controlling a device according to the first aspect or any of its implementation forms or for performing, when the program code is executed on a computer, a method according to the second aspect or any of its implementation forms.

Accordingly, all the advantages and effects described above with respect to the device of the first aspect and the method of the second aspect, respectively, are achieved.

It has to be noted that all devices, elements, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF THE DRAWINGS

The above described aspects and implementation forms of the invention will be explained in the following description of specific embodiments in relation to the enclosed drawings, in which

FIG. 1 shows a device according to an embodiment of the invention.

FIG. 2 illustrates schematically how a device according to an embodiment of the invention creates a 3D image.

FIG. 3 shows a method according to an embodiment of the invention.

FIG. 4 shows an algorithm carried out by a device according to an embodiment of the invention.

### DETAILED DESCRIPTION OF THE EMBODIMENTS

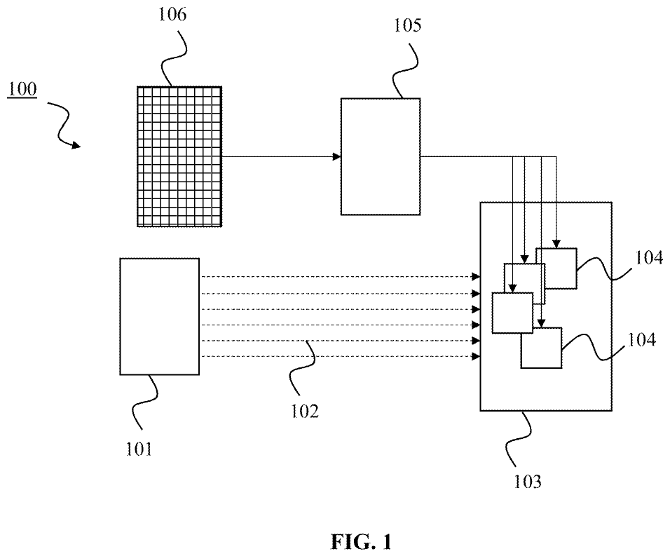

FIG. 1 shows a device 100 according to an embodiment of the invention. The device 100 is particularly configured to display a 3D image. The 3D image to be displayed may be received by the device 100, e.g., by an input video steam. Generally, any 3D image to be displayed may be rendered by the device 100 based on a 2D image and a depth map 106. These may be generated by the device 100 from the 3D image to be displayed, as explained later.

The device 100 comprises a light source 101, a diffuser 103, and a controller 105. The light source 101 is configured to emit light beams 102. Each light beam 102 thereby corresponds to a pixel of a 2D image. The diffuser 103 is further configured to diffuse the light beams emitted from the light source 101. In particular, the diffuser 103 to this end includes a plurality of diffuser elements 104, which are distributed across a 3D volume. In FIG. 1 for illustrational purposes only, four diffuser elements 104 are shown. Each diffuser element 104 of the diffuser 103 is individually controllable to be transmissive or diffusive, particularly by means of the controller 105 as indicated by the respective arrows in FIG. 1 That is, the controller 105 is configured to control each diffuser element 104 to be transmissive or diffusive based on the depth map 106. This results in the creation of the 3D image.

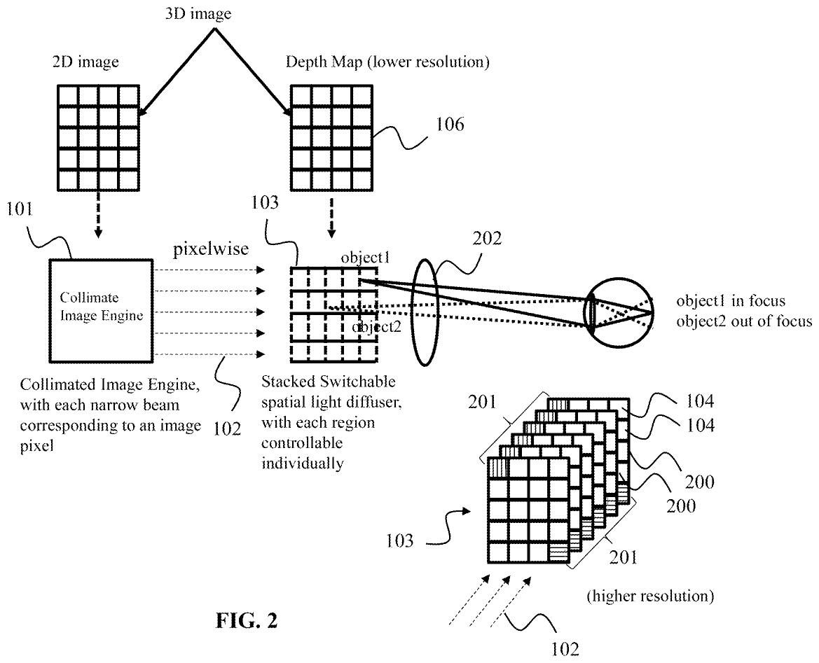

FIG. 2 illustrates schematically how a device 100 according to an embodiment of the invention generates the 3D image. FIG. 2 thereby bases on the device 100 shown in FIG. 1, i.e. same elements are labelled with the same reference signs and function likewise. In particular, FIG. 2 shows that the 3D image to be displayed can be represented by a 2D image and a depth map 106. Thus, the diffuser 103 with its individually controllable diffuser elements 104 can be controlled to generate the 3D image based on the 2D image and the depth map 106. Notably, the higher the number of diffuser elements 104 being employed, the higher the depth of the 3D image that can be rendered by the device 100. The depth map 106 usually has a lower resolution than the 2D image.

As is shown in FIG. 2, a collimated image engine may be used as the light source 101. It takes the 2D image as an input, and is accordingly configured to output a set of narrow light beams 102, wherein each light beam 102 corresponds to an image pixel of the 2D image. The diffuser 103 takes these narrow light beams 102, i.e. the light beams 102 impinge on the diffuser 103 which is configured to diffuse them based on the depth map 106, i.e. as shown in FIG. 1 by the controller 105 receiving the depth map 106 as an input.

In particular, the diffuser 103 includes the plurality of individually controllable diffuser elements 104, which are distributed across a 3D volume. As shown in FIG. 2, the diffuser elements 104 are arranged in a plurality of layers, wherein each layer 200 may be associated with a different depth in the 3D image. The shown layers 200 are particularly arranged one after the other in direction of the light beams 102 and are spaced apart from each other. Preferably, the diffuser elements 104 in each layer 200 adjoin each other.

As further shown in FIG. 2, the diffuser elements 104 are also arranged in columns 201 two different columns are indicated in FIG. 2 by different hatchings), wherein each column 201 comprises diffuser elements 104 located in different layers 200. There may be one column 201 per pixel of the 2D image, or one column 201 per group of pixels of the 2D image, each group comprising several pixels. That is, each column 201 may be associated with one or more narrow light beams 102. For each narrow light beam 102 a certain diffuser element 104 may be switched on. When a diffuser element 104 is switched on, it will diffuse the incoming narrow light beam 102 before it is projected directly to the eye (pupil). Specifically, to generate the 3D image, the controller 105 may particularly be configured to select, for each column 201, one layer 200 based on the depth map 106 and to control the one diffuser element 104 of the column 201 which is located in the selected layer 200 to be diffusive and to control the one or more diffuser elements 104 of the column 201 which are located in the one or more non-selected layers 200 to be transmissive. The selected diffuser elements 104 of the diffuser 103 may correspond to an estimated depth of the pixels. As also illustrated in FIG. 2, when the eye is focusing on an object 1 in the image, an object 2 is naturally out of focus.

FIG. 2 also shows that a magnifier 202, e.g., a lens, can be arranged on an exit side of the diffuser 103. The magnifier 202 allows a user to view an enlarged 3D image.

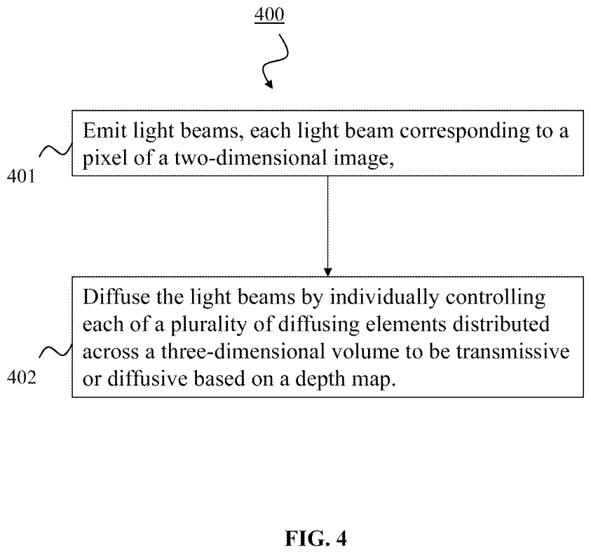

The controller 105 of the device 100 may further be configured to decompose the 3D image to be displayed (e.g., as received) into the 2D image and the depth map 106. Then, the controller 105 can control the light source 101 based on the 2D image, and can control the diffuser 103 based on the depth map 106. The controller 105 may also be configured to calculate a predicted depth map for a next 3D image based on the depth map 106, and to obtain a depth estimate of the next 3D image based on the predicted depth map. An example implementation thereof is shown in FIG. 4.

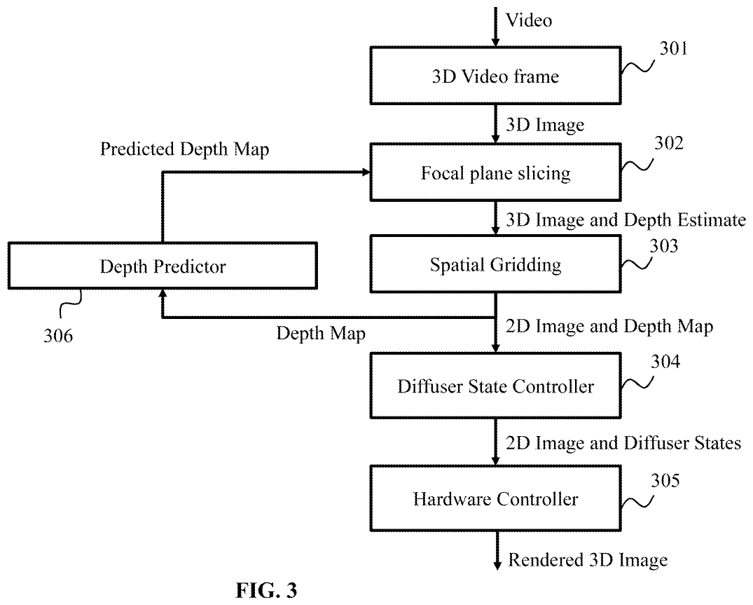

FIG. 3 shows particularly a block diagram for processing an incoming video stream containing a sequence of 3D images to be displayed. The processing shown in FIG. 3 may be carried out by the controller 105 (which receives the video stream). The video stream may accordingly be fed into the device 100 of FIG. 1.

A block 301 “3D Video Frame” extracts a 3D Image from the video stream and feeds it to the block 302 “Focal Plane Slicing”. Block 302 estimates the depth of the current image (or the number of focal planes (depths) present in the current 3D image). The 3D image and the depth estimate are forwarded to block 303 “Spatial Gridding”, which decomposes the 3D image into a 2D image and a depth map 106. The next block 304 “Diffuser State Controller” takes the depth map 106 to select the diffusing layer state to be assigned to each pixel, and it forwards the 2D image data. Finally, both the 2D image and a set of diffusing layer states are used by block 305 “Hardware Controller”, which may be implemented by the controller 105, in order to render the 3D image. For the next frame, a “Depth Predictor” may be applied in block 306, in order to predict the depth distribution of the next 3D image. The different blocks may represent different functional steps, which the controller 105 is able to implement.

FIG. 4 shows a method 400 according to an embodiment of the invention. The method 400 may be performed by a device for displaying a 3D image, particularly by the device 100 shown in FIG. 1 (and schematically explained in FIG. 2). The method 400 is usable for displaying a 3D image. The method 400 comprises a step 401 of emitting light beams 102, each light beam 102 corresponding to a pixel of a 2D image. Further, the method 400 comprises a step 402 of diffusing the light beams 102 by individually controlling each of a plurality of diffusing elements 104 distributed across a 3D volume to be transmissive or diffusive based on a depth map 106.

The invention has been described in conjunction with various embodiments as examples as well as implementations. However, other variations can be understood and effected by those persons skilled in the art and practicing the claimed invention, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

What is claimed is:

1. Device (100) for displaying a three-dimensional (3D) image, the device (100) comprising
a light source (101) configured to emit light beams (102), each light beam (102) corresponding to a pixel of a two-dimensional (2D) image, and
a diffuser (103) configured to diffuse the light beams (102),
wherein the diffuser (103) includes a plurality of diffuser elements (104) distributed across a three-dimensional volume, and each diffuser element (104) is individually controllable to be transmissive or diffusive, and
a controller (105) configured to control each diffuser element (104) to be transmissive or diffusive based on a depth map (106).

2. Device (100) according to claim 1, wherein the diffuser elements (104) are arranged in a plurality of layers (200).

3. Device (100) according to claim 2, wherein the diffuser elements (104) are arranged in columns (201), each column (201) comprising diffuser elements (104) located in different layers (200).

4. Device (100) according to claim 3, wherein the controller (105) is configured to select, for each column (201), one layer (200) based on the depth map (106) and to control the one diffuser element (104) of the column (201) which is located in the selected layer (200) to be diffusive and to control the one or more diffuser elements (104) of the column (201) which are located in the one or more non-selected layers (200) to be transmissive.

5. Device (100) according to claim 2, wherein the diffuser elements (104) in each layer (200) adjoin each other.

6. Device (100) according to claim 2, wherein the layers (200) are spaced apart from each other.

7. Device (100) according to claim 3, wherein
there is one column (201) per pixel,
or wherein there is one column (201) per group of pixels, each group comprising several pixels.

8. Device (100) according to claim 2, wherein
each layer (200) is associated with a different depth in the 3D image.

9. Device (100) according to claim 1, wherein
the depth map (106) has a lower resolution than the 2D image.

10. Device (100) according to claim 1, wherein
the controller (105) is further configured to decompose (303) the 3D image into the 2D image and the depth map (106), to control the light source (101) based on the 2D image, and to control the diffuser (103) based on the depth map (106).

11. Device (100) according to claim 1, wherein
the controller (105) is further configured to calculate (306) a predicted depth map for a next 3D image based on the depth map (106), and to obtain (302) a depth estimate of the next 3D image based on the predicted depth map.

12. Device (100) according to claim 1, further comprising a magnifier (202) arranged on an exit side of the diffuser (103).

13. Device (100) according to claim 12, wherein the magnifier (200) has a focal plane and the diffuser (103) comprises a plurality of diffuser layers, the diffuser layers including:
a first diffuser layer located in the focal plane or located between the focal plane and the magnifier (200), and
one or more further diffuser layers located between the first diffuser layer and the magnifier (200).

14. Method (400) for displaying a three-dimensional (3D) image, the method (400) comprising
emitting (401) light beams (102), each light beam (102) corresponding to a pixel of a two-dimensional (2D) image,
diffusing (402) the light beams (102) by individually controlling each of a plurality of diffusing elements (104) distributed across a three-dimensional volume to be transmissive or diffusive based on a depth map (106).

15. Computer program product comprising a program code for controlling a device (100) according to claim 1 or for performing, when the program code is executed on a computer.
